(19) United States
(12) Patent Application Publication
(10) Pub. No.: US 2026/0158983 A1
(43) Pub. Date: Jun. 11, 2026

(54) INTERIOR PART WITH A TABLE

(71) Applicant: FCA US LLC, Auburn Hills, MI (US)

(72) Inventors: Ying Pauline Wu, Shanghai (CN); Wei Fang, Shanghai (CN); Zhongyun Feng, Shanghai (CN); Xuezhong Fu, Shanghai (CN)

(21) Appl. No.: 18/973,464

(22) Filed: Dec. 9, 2024

(51) Int. Cl. B60N 3/00; B60Q 3/20

(52) U.S. Cl. CPC B60N 3/002; B60Q 3/20; B60R 7/04

(57) ABSTRACT

A vehicle interior module has a framework to connect to a vehicle dashboard. The framework includes an opening to receive a console part. A deck is positioned on the framework. A table is secured with the deck of the framework. A skirt is attached to the framework to cover the framework from view. At least one power adapter in the framework for enabling powering of mobile devices and accessories.

### CROSS-REFERENCE TO RELATED APPLICATION

The present application is related in general subject matter to pending U.S. patent application Ser. No. ______ (Attorney Docket No. 712618US1), filed concurrently herewith, entitled “Interior Part Connection,” assigned to FCA US LLC, and hereby incorporated by reference in its entirety into the present application.

### FIELD

The present disclosure relates to vehicles and, more particularly, to a vehicle console including a table.

### BACKGROUND

This section provides background information related to the present disclosure which is not necessarily prior art.

In automotive vehicles, the interiors generally include a dashboard as well as console between the seats. More and more vehicles desire a device to retain articles, such as personal articles, cell phones, pens and small pads, between the seats. Generally, there is a need for an article holder or the like between the seats.

Various types of article holders exist between seats of a vehicle. Generally, they may include a portion of the console which has a glove box or the like to retain articles inside of it. While this type of device is satisfactory for its use, designers strive to improve the art.

The present disclosure provides a fixed table on a portion of the console that projects from the dashboard. The interior article could guide a passenger knee during impact or the like. Additionally, the table could receive cell phones or the like and include a pad for powering the cell phone. Further, the table could receive personal things such as pads, pens, pencil and papers inside a groove on the table during driving. The interior part could include a 12 volt or a USB or USC port for charging or use of a device. The table is generally utilized when the vehicle is at rest.

### SUMMARY

This section provides a general summary of the disclosure, and is not a comprehensive disclosure of its full scope or all of its features.

According to the present disclosure, a vehicle interior module includes a framework to connect to a vehicle dashboard. The framework includes an opening to receive a console part. A deck is positioned on the top of the framework. A table is secured with the deck. A skirt attaches to the framework to cover the framework from view. At least one power adaptor is in the framework to enable powering of mobile devices and accessories. The table includes a groove or the like to retain writing instruments or coins. The skirt guides a person's knee during movement in the seat. Framework has an opening that includes two sidewalls and a pair of guide grooves with one groove on each side of the opening. The opening walls include a recess to receive a centering pin. An ambient light source is connected with the table. A spotlight is secured to the framework to shine into a console. The skirt surrounds the opening sidewalls.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic perspective view of the interior part.

FIG. 2 is an exploded perspective view of the part of FIG. 1.

FIG. 3 is a bottom perspective view of the interior part.

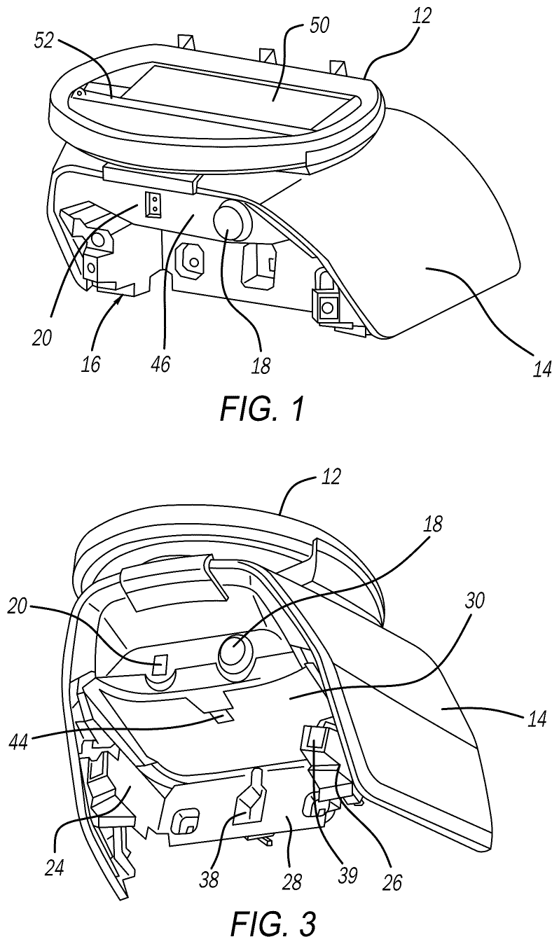

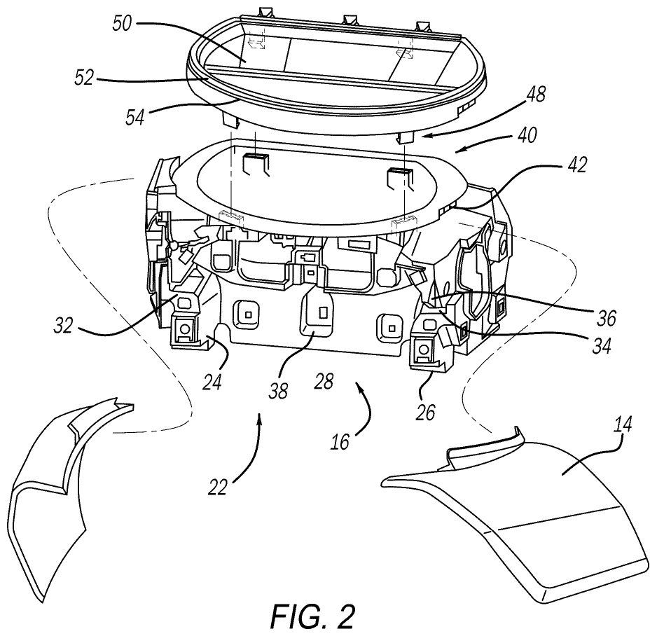

Corresponding reference numerals indicate corresponding parts throughout the several views of the drawings.

### DETAILED DESCRIPTION

Example embodiments will now be described more fully with reference to the accompanying drawings.

Turning the figures, an interior part is illustrated and designated with the reference numeral 10. The interior part 10 includes a table 12, an outer skirt 14 and framework 16. A 12 volt receptacle 18 is secured with the framework 16. Also, the framework 16 includes a USB or USC port 20.

The framework 16 includes a console receiving opening 22 having a pair of sidewalls 24, 26 as well as rear wall 28 that defines the opening. The opening 22 also includes a roof 30 to limit the opening 22. The sidewalls 24, 26 have a ledge 32 defining a guide groove 34. The guide groove receives the console. Also, a guide surface 36 projects from the roof 30 to limit the guide grooves 34 to enable insertion of a console into the framework opening 22. Also, the backwall 28 includes a recess 38 to receive a console pin (not shown). The walls 24, 26 include apertures 40 to receive stop pins from a console. A console is like that disclosed in U.S. patent application Ser. No. ______, entitled “Interior Part Connection”, filed ______, the specification and drawings which are herein incorporated by reference.

The framework 16 includes a deck 40 that projects from the framework 16. The deck 40 has a circular configuration to receive the table 12. The table 12 is secured to the deck 40 by tangs 48. The deck 40 may include an ambient light 42 to provide light. Also, the light may shine onto the table 12. The roof may include a spotlight 44 that shines into a console basket. The light 44 is present so that when the console is open, a user has light to see within the basket.

The panel 46 receives the 12 volt connector 18 as well as the USB or USC port 20.

The table 12 has an overall circular configuration. The table 16 may include a mat 50 that is electrically charged so that it may charge a cell phone or the like. Also, the table may include a groove 52 or the like to retain a writing instrument or coins on the table. Additionally, a surface 54 is on the table that may receive a beverage or the like.

The framework 16 also includes securement members to secure it with a dashboard. Thus, the framework is secured with a dash and included the opening to receive a console.

The table 12 and skirt 14 are applied to the framework 16. They are held in place by conventional fasteners or glued to the framework. The table 12 is received onto the framework deck and secured therewith.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle interior module comprising:
a framework for connecting to a vehicle dashboard, the framework including an opening for receiving a console part, a deck is positioned on the framework;
a table securing with the deck of the framework;
a skirt attached to the framework for covering the framework from view;
at least one power adapter in the framework for enabling powering of mobile devices and accessories.

2. The vehicle interior module of claim 1, wherein the table includes a groove for retaining writing instrument.

3. The vehicle interior module of claim 1, wherein the skirt guides a person's knee.

4. The vehicle interior module of claim 1, wherein the framework includes:
two sidewalls, a pair of guide grooves, one groove on each side of the opening; and
an aperture in the sidewalls for receiving console guide pins.

5. The vehicle interior module of claim 1, wherein the opening wall includes a recess for receiving a centering pin.

6. The vehicle interior module of claim 1, wherein an ambient light source is connected with the table.

7. The vehicle interior module of claim 1, wherein a spot light is secured to the framework for shining into a console.

8. The vehicle interior module of claim 1, wherein the skirt surrounds the opening sidewalls.
